(19) United States
(12) Patent Application Publication
(10) Pub. No.: US 2026/0226815 A1
(43) Pub. Date: Aug. 6, 2026

(54) POROUS POLYMERIC MATERIAL AND FILTRATION DEVICE

(71) Applicant: Baker Hughes Oilfield Operations LLC, Houston, TX (US)

(72) Inventors: Ping Duan, Cypress, TX (US); Vimal Shah, Sugar Land, TX (US)

(21) Appl. No.: 19/042,431

(22) Filed: Jan. 31, 2025

(51) Int. Cl. E21B 43/10; B01D 39/16; C08J 3/24; C09K 8/50

(52) U.S. Cl. CPC E21B 43/108; B01D 39/16; B29C 66/73117; C08J 3/247; C09K 8/50; B01D 2239/0291; B01D 2239/10; B01D 2239/1291; C08J 2371/08; C08J 2381/02

(57) ABSTRACT

A material, comprising a crosslinked polymeric material with a dry density of 0.1 g/cm³ to 0.7 g/cm³, and an open volume of 60% to 99.5%, and a fluid control device that includes the polymeric material. The polymeric material exhibits a rubbery plateau above the glass transition temperature of a precursor polymer from which the material is prepared. The fluid control device includes a filtration medium including the polymeric material, which is configured to expand and remain in contact with a support structure and provide permeability to the filtration medium.

### BACKGROUND

Various tools are utilized in subterranean operations, such as hydrocarbon exploration, drilling and completion operations, to increase or maximize production efficiency. Sand control devices such as sand screens are utilized to control the ingress of particulates and thereby minimize contamination to the production fluid as well as help in stabilize production formations. Examples of sand control devices include screen assemblies having conformable sleeves or components that are expanded downhole. For example, one conforming expandable screen includes a self-swelling material that expands in volume upon contact with a well fluid. See, U.S. Pat. No. 7,318,481, assigned to Baker Hughes Inc. The self-swelling material is a thermosetting open cell shape memory foam, which is designed with a desired transition temperature slightly below the anticipated downhole temperature. As the temperature of the shape memory foam increases downhole, the transition temperature is surpassed, and the foam expands.

It is of interest to develop novel porous materials that is both thermally and chemically resistant to conditions in below ground borehole formations and to deploy such materials in a flow control device for production fluids, e.g., hydrocarbon fluids.

### BRIEF DESCRIPTION OF THE INVENTION

A material, comprising: a crosslinked polymeric material with a dry density of 0.1 g/cm³ to 0.7 g/cm³, and an open volume of 60% to 99.5%, based on a total of open and closed volume. The polymeric material exhibits a rubbery plateau above the glass transition temperature of a precursor polymer from which the material is prepared.

A fluid control device that includes the crosslinked polymeric material is also described. The fluid control device includes:
a support structure including a fluid passage and configured to be deployed in a borehole;
a filtration medium including the crosslinked polymeric material, the filtration medium disposed in contact with the support structure. The polymeric material is configured to expand and remain in contact with the support structure to increase permeability of the filtration medium.

A fluid control method comprising:
deploying the fluid control device of claim 11 in the borehole, wherein the crosslinked polymeric material is in a compressed form during deployment;
expanding the compressed polymeric material in the plurality of fluid passages to provide an increase in permeability to the filtration medium, the polymeric material conforming to a surface of the support structure; and
allowing a fluid to flow through the filtration medium to separate and remove undesirable material from the fluid.

A method of making a permeable material, the method comprising:
blending a salt and a precursor polymer to provide an admixture;
compacting the admixture under pressure in a mold to provide a compacted admixture;
heating the compacted admixture to a temperature above the glass transition temperature of the precursor polymer; and
extracting the salt from the heat-treated admixture to provide the permeable material.

### BRIEF DESCRIPTION OF THE DRAWINGS

The following descriptions should not be considered limiting in any way. With reference to the accompanying drawings, like elements are numbered alike.

FIG. 1 is a plot of amorphous PPS-PXM polymeric materials that were heat-treated at different temperatures, and thereby, respectively each exhibit different glass transition temperatures. A plot of the glass transition temperature for an amorphous PEEK polymeric material is also shown.

FIG. 2 is a Differential Scanning Calorimetry (DSC) plot of PEEK as a precursor resin and following heat treatment.

FIG. 3 is a Differential Scanning Calorimetry (DSC) plot of PPS as a precursor resin and following heat treatment.

FIG. 4 depicts an embodiment of a downhole completion and/or production system including an expandable and conformable screen assembly.

### DETAILED DESCRIPTION OF THE INVENTION

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of ±8% of a given value.

A crosslinked polymeric material in a form of a porous or permeable foam-like material, which exhibits a rubbery plateau above the glass transition temperature of a precursor polymer resin from which the polymeric material is prepared is disclosed.

The polymeric material (alone or in combination with other materials) is configured as a porous or permeable structure, e.g., with open or closed cells or channels through which a production fluid can readily flow or pass through to remove undesired solids from the fluid. In an embodiment, the polymeric material is a permeable structure with primarily open channels, and therefore, in its expanded state as described herein, the polymeric material provides a filtration material having highly efficient fluid flow. Following the expansion of the polymeric material downhole, the permeable structure filters the fluid entering the fluid control device (e.g., production fluid including formation fluids such as oil and hydrocarbon gas).

At times, the terms “porous” and “permeable” are used interchangeably to characterize the open and closed (cell or channel) volume of the polymeric material. The open volume can be characterized as having open pores, open channels, e.g., intersecting (intertwining) open channels of varying shape, to provide a complex labyrinth of open volume through which a fluid would readily flow.

As stated, the permeable structure primarily includes open cells or channels in contrast to closed cells or channels. In an embodiment, the polymeric material, e.g., in the expanded state or following the making of the material prior to compression, includes a permeable structure that includes greater than 60% volume of open cells and channels (hereafter, “open volume”) to a volume of closed cells and channels (closed volume), based on a total volume of open and closed volume. In fact, the technical advantages to the polymeric material is the relatively large open volume including open cells or connecting channels as compared to that of closed cells (closed volume), the former of which provides a more efficient flow or permeability to a production fluid. In some instances, the polymeric material provides a permeable structure that includes greater than 70% of open volume, greater than 80% of open volume, or greater than 90% of open volume, based on a total volume of open and closed volume of the material.

In an embodiment, the polymeric material provides a permeable structure that includes greater than 95% open volume based on a total volume of open and closed volume of the material.

Devices, systems and methods for controlling sand and other undesirable material in a downhole environment are also described. An embodiment of a fluid control device includes a screen assembly having a conformable and expandable filtration medium that includes a filtration medium including a polymeric material described herein such that the permeable structure provides fluid passages for a fluid, e.g., a production fluid in a wellbore. As described herein, the polymeric material may be compacted from an initial manufactured shape by raising the temperature at or near its glass transition temperature to soften the material. The material is then compressed to reduce the total volume of the material and rapidly cooled. The compacted polymeric material is delivered to a production site and positioned in a fluid control device in a compacted shape. The fluid control device is then positioned in the borehole, and the filtration medium (polymeric material) can be expanded downhole by activating the shape memory of the material.

The degree to which the polymeric material may be compacted to provide a compacted polymeric material will in-part depend upon the type of precursor polymers used to make the polymeric material, a degree of crosslinking in the material, an initial amount of open volume (manufactured open volume following extraction), and/or the technical application or specification of the polymer material in a fluid control device including the volume parameters of the device structure and the surrounding borehole formation.

In an embodiment, the compacted polymeric material may have an open volume that is 80% or less, for example, 70% or less or 50% or less, than that of the polymeric material in its fully expanded stated, e.g., the open volume of the material following extraction of the salt as described herein.

In an embodiment, a polymeric material in a fully expanded state may have a water permeability of 10 darcy to 40 darcy, e.g., a water permeability of 15 darcy to 30 darcy, whereas in a compacted state as defined above, the polymeric material may have a water permeability of 0.02 darcy to 5 darcy. Likewise, the polymeric material in a fully expanded state may have a IBF Oil permeability of 30 darcy to 110 darcy whereas in a compacted state as defined above, the polymeric material may have a IBF Oil permeability of 0.1 darcy to 10 darcy or 0.1 darcy to 5 darcy.

Expansion of the polymeric material downhole may take place in response to existing downhole conditions (e.g., temperature and or borehole fluid composition), or by an injection of a triggering fluid, e.g., GeoWASH™, that comes in contact with the compacted polymeric material. For example, a temperature of a downhole environment of 120°, 140° C., or 160° C. or higher may be sufficient to heat the polymeric material past the glass transition temperature resulting in an expansion of the compacted foam to at or near its original volume and/or shape thereby forming a virtual seal against a surface of the fluid control device.

In an embodiment, a polymeric foam material described includes an amorphous, crosslinked polymeric material including the open and closed volume with a dry density of 0.1 g/cm³ to 0.7 g/cm³, 0.1 g/cm³ to 0.5 g/cm³, or 0.15 g/cm³ to 0.45 g/cm³. For example, the density of the amorphous crosslinked polymeric foam material maybe from 0.15 g/cm³ to 0.3 g/cm³.

The polymeric foam material is a permeable polymeric material with a an open volume of 40% to 95%, 50% to 95%, or 60% to 95%, based on a total of open and closed volume of the material.

At times, herein, the terms material, polymer material, polymeric material, amorphous polymeric material, or amorphous crosslinked polymeric material, may be used interchangeably and correspond to any physical shape of the material including a material in its unsintered or sintered form, a material in a fully compressed state, a fully expanded state, or any volume state between the fully compressed state and a fully expanded state.

The polymeric foam material described is highly permeable. As such, water can freely pass through the material with minimal resistance or delay. For example, if the polymeric material is placed in a water bath, the open volume in the material almost immediately begins to fill with water and the material eventually sinks to the bottom of the bath container. The total of open and closed volume of the polymeric material may be experimentally measured with a Densimeter based on their dimensions, dry weight and wet weight in water.

An crosslinked polymeric material may be formed from an admixture of a precursor polymer, e.g., a polymer powder and a salt that is initially compressed in a mold. The material is then subjected to a heat temperature (sintering temperature) at high temperatures above its melting temperatures as described herein. In one embodiment the compacted and heat-treated material may then be taken out of the mold before the sintering process. In some instances, which in-part depends upon the precursor polymer, the glass transition of the crosslinked polymeric material may be controlled or varied by the heat-treatment temperature used in the process of making the material. The crosslinked polymeric material may be best described as an amorphous polymeric material.

The precursor polymer may be available from a third party in a powder form, for example, a precursor polymer powder may have a mesh size of 500 to 3.

In an embodiment, the crosslinked polymeric material may exhibit a glass transition temperature in a range of 90° C. to 170°, e.g., in a range of 100° C. to 150°, and therefore, the material may be designed or set to activate, i.e., expand from a compressed state to an expanded state at various temperatures higher than the glass transition temperature of the material or at various depths of any borehole formation. As described latter herein, the material may be positioned in or near the borehole at a set depth below the surface in a compacted state.

In an embodiment, crosslinked polymeric material may be prepared as follows. A precursor polymer, e.g., a thermoplastic polymer in a form of a commercial-available powder, is blended with particles of a soluble salt, e.g., a water, alcohol, or mixed water/alcohol, soluble salt. For example, the salt can be any water-soluble salt such as ordinary table salt, NaCl, which has a diameter particle size of about 0.1 to 0.3 mm. Of course, a person of ordinary skill would understand and recognize that any soluble salt, e.g., any water-soluble salt, can be used to prepare the crosslinked polymeric material, and therefore, the compositional type or particle size of the salt is not particularly limited to the making of the material.

The salt particles are blended (mixed) with the precursor polymer in a weight ratio of salt to precursor polymer of 95:5, 90:10, 80:20, 70:30, or 60:40. For example, a weight ratio of the salt to the precursor polymer in the molded form is from about 10:1 to about 2:1.

The diameter particle size of the salt can range from about 0.03 mm to 4 mm, 0.05 to 2 mm, or 0.1 to 1 mm. The particle size of the soluble salt can also be stated or dictated by a mesh size. For example, the particle size of the salt may have a mesh size in a range from 400 (fine) to 5 (course). As described, the particle or grain size of the salt is stated in a diameter particle size, but, of course, a person of ordinary skill understands and recognizes that the salt particles may have any random shape or a mixture of different particle shapes.

In an embodiment, one may find an advantage in having an admixture of precursor and salt in which the salt particles are of different mesh size and/or different particle shapes to provide a more varied porosity, that is, a porosity in terms of size and shape of open pores or open channels in the crosslinked polymeric material.

In an embodiment, one may find an advantage in having an admixture of polymer precursor and salt in which the salt particles are of one or similar mesh size and shapes to provide a more uniform porosity or channel permeability in terms of size and shape of pores (channels) in the crosslinked polymeric material.

The size of open pores or channels in the crosslinked polymeric material are determined in-part by the size of the soluble salt particles. In an embodiment, the soluble salt particles may be varied in different parts of the model to achieve desired variable permeability of the polymeric material.

In an embodiment, off-the-shelf table salt can be used, and in general, may be preferred over off-the-shelf Kosher-size salt. In another embodiment, one may prepare an admixture of precursor polymer and salt in which the salt is a mixture of off-the-shelf table salt and off-the-shelf Kosher-size salt.

The relative particle (or mesh) size of the salt to precursor polymer (e.g., a polymer powder) is about 4:1 to about 1:4, about 3:1 to about 1:3, or about 2:1 to about 1:2, to ensure a relatively uniform admixture of the salt to the polymer, that is, to prevent or minimize a gravitational separation of the salt from the polymer in the admixture during the blending or mixing process.

A method of blending the salt and the precursor polymer (powder polymer) may be performed by adding both the salt and precursor polymer to a bottle or container in a set weight ratio and mixing by hand or with a tumbler for one or two minutes. For preparing larger commercial scale admixtures a commercial powder blender, e.g., a double cone bender, model number DCB-5 available from Charles Ross & Son Company, may be used. The admixture of salt and precursor polymer are added to a steel mold, which allows for the compaction or pressing of the admixture into a molded form. Again, because of a relative difference in size and/or shape of the salt and the precursor polymer, the molded form can be more or less uniform in terms of the admixture of salt to polymer in the molded form.

For example, the steel mold can include top and bottom plates, a center ring and a center hydraulic piston. The admixture is added to the mold and the admixture compacted (pressed) to form a shape (e.g., a disc) of varying diameter and height (or volume). The compacted admixture may be removed from the mold, and the molded admixture (discs) are placed inside a high temperature oven. Alternatively, the compacted admixture may be heated without removing the compacted admixture from the mold.

The temperature of the oven is set above the melting point of the precursor polymer. For most precursor polymers, an oven temperature in a range from 250° C. to 500° C. is sufficient. The heat-treatment range is determined in-part in accordance with the type of precursor polymer and the knowledge of a person of ordinary skill. As understood, the temperature of the oven is not too high above the melt temperature of the precursor polymer, nor is the heat treatment time too long to cause physical separation of the polymer from the salt in the molded form. Rather, the temperature and time of heating is set to just allow the polymer to soften, form around the salt particles with minimum settling of the salt particles in the molded form, and crosslink during the heat treatment. The heated, compacted admixture is then removed from the oven and allowed to cool to room temperature.

The heat-treated admixture is added to water to dissolve or extract the embedded salt particles from the material. It is necessary for the solvent (water, alcohol, or thereof) to reach each salt particle to dissolve and leach the salt out of the heat-treated admixture. Hence by design the heat-treated polymeric material is an open cell foam and its porosity is directly related to its permeability. For example, the heat-treated admixture may be placed in boiling water for about 6 to 72 hours. The resulting polymeric material is then removed from the water and placed into a drying oven (90 to 120° C. for about 5-10 hours) to remove most if not all of the water from the now porous, permeable material-the open and closed volume result in-part from the positions of the salt grains in the heat-treated, compacted form.

It is believed that the heat treatment (sintering) of the precursor polymer above its melting point in the making of the molded porous material may result in oxidation of the polymer, which alters the polymer from a linear crystallized thermoplastic polymer to an amorphous, crosslinked polymeric material. The amorphous, crosslinked polymeric material differs from the initial crystallized thermoplastic polymer, that is, the precursor, in that the amorphous crosslinked amorphous polymeric material exhibits rubbery-like elastomeric property over a relatively wide temperature range including at temperatures above the glass transition temperature of the precursor polymer from which it is prepared. The high temperature properties of the porous polymeric material may be analyzed and determined by Differential Scanning Calorimeter (DSC) and Dynamic Mechanical Analyzer (DMA).

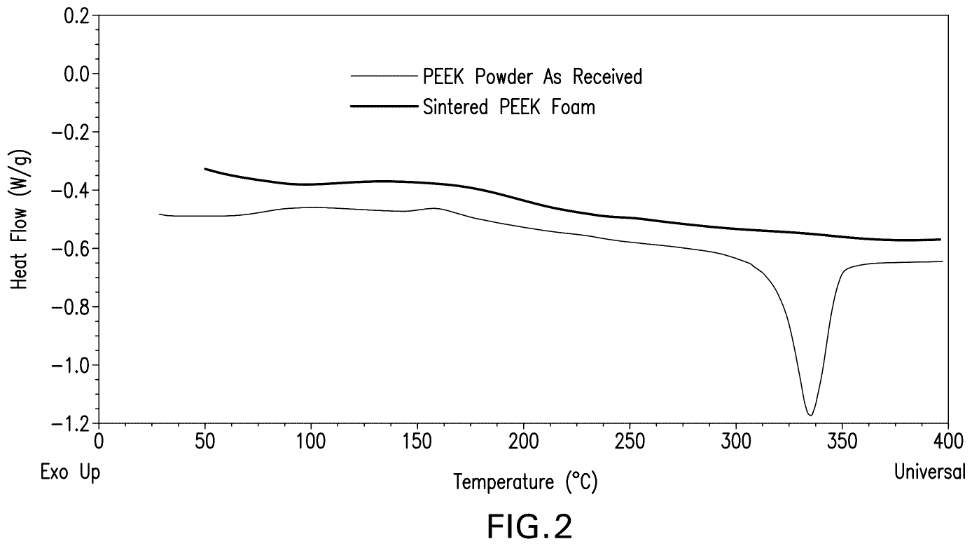

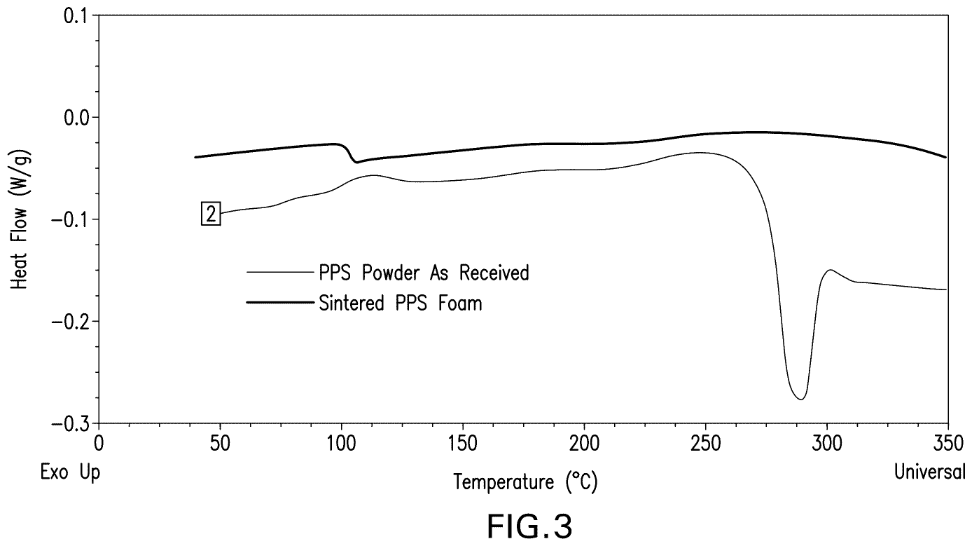

As demonstrated, FIG. 2 is a DSC plot of polyether ether ketone (PEEK) as a precursor and following the heat treatment as described to prepare the corresponding porous, crosslinked amorphous polymeric material. FIG. 3 is a DSC plot of polyphenylene sulfide (PPS) as a precursor and following heat treatment as described to prepare the corresponding porous, crosslinked amorphous polymeric material.

After the porous molded polymeric material is prepared as described above, the polymeric material is heated slightly above the original glass transition temperature of the precursor polymer. For example, the polymeric material may be heated 20° C. to 70° C. above the glass transition temperature to soften the characteristic plastic-like polymeric material. In this softened state, i.e., at a temperature in which the polymeric material exhibits a rubbery-plateau, the polymeric material is compressed to reduce the volume of the initially prepared polymeric material following salt extraction to a compressed volume. Once in a desired compressed state, the temperature of the polymeric material is quickly lowered to lock-in the compressed volume of the polymeric material. One may say that the locked polymeric material is in the form of a fixed-compressed polymeric foam.

In an embodiment, a polymeric material in a compressed state may have a volume that is about 15% to 85% of the initial (prepared) volume. For example, a compressed volume may be about 15% to 70 %, or about 20% to 50%, of the initial (prepared) volume of the polymeric material.

In fact, the compressed shape and volume of the compressed polymeric material is stable for an extended length of time, and therefore, the compressed material can be stored for any length of time or transported to a production site in the compressed state. As described in greater detail below, the compressed material may be positioned in a fluid control device as one component of a filtration medium or filtration assembly.

In addition, the crosslinked polymeric material is shown to be very stable at elevated temperatures or downhole application temperatures. The polymeric material is shown to withstand a high temperature environment, e.g. the material does not significantly degrade during an operation and/or during an operational life of a fluid control device. Moreover, the crosslinked polymeric material is shown to be a chemically resistant material in that the material may be used in a downhole environment without significant damage or degradation of the material from the exposure to various fluids and chemicals encountered downhole including, for example, chemicals entering a borehole from a subterranean region and/or chemicals injected into the borehole.

The precursor polymer may be selected from any of a variety of polymers. A couple of technical considerations for the selection of the precursor polymer is the high temperature stability and/or the chemical stability of the polymer. In terms of the temperature requirements, the polymer should possess thermal stability at the heat-treating (sintering) conditions during the preparation of the crosslinked polymeric material. In terms of chemical stability or chemical resistance, the polymeric material is relatively resistant to chemical reaction and/or degradation in the presence of chemicals found in downhole production environments. As described herein, a “chemically resistant” material is a material that does not significantly degrade in the presence of chemical substances found or introduced downhole (e.g., hydrocarbons, gases, etc.), at least for a period of time that exceeds a desired length of an operation and/or a desired useful life of the filtration control device.

The precursor polymer may include a single polymer or a combination of two or more polymer resins. For example, the precursor polymer may be a fluoropolymer, an aromatic polyamide, or an aromatic sulfone. For example, a fluoropolymer may include fluorinated ethylene propylene (FEP), perfluoroalkoxy polymer (PFA), or polytetrafluoroethylene (PTFE). Other polymer may include polyphenylsulfone (PPSU), polyarylsulfone (PSU), self-reinforced polyphenylene (SRP), polyetherketoneketone (PEKK), polyphenylene sulfide (PPS), polyether ether ketone (PEEK), or a combination thereof.

In an embodiment, the precursor polymer is at least one of polyether ether ketone (PEEK), polyetherketoneketone (PEKK), or polyphenylene sulfide (PPS).

In an embodiment, the precursor polymer is a restively high molecular weight polyphenylene sulfide, e.g., a resin referred to in the art as PPS-PXM, available as Ryton® PXM from Syensqo. PPS-PXM is reported to have a molecular weight greater than 5,000 g/mol, e.g., from 5000 to 100,000 g/mole.

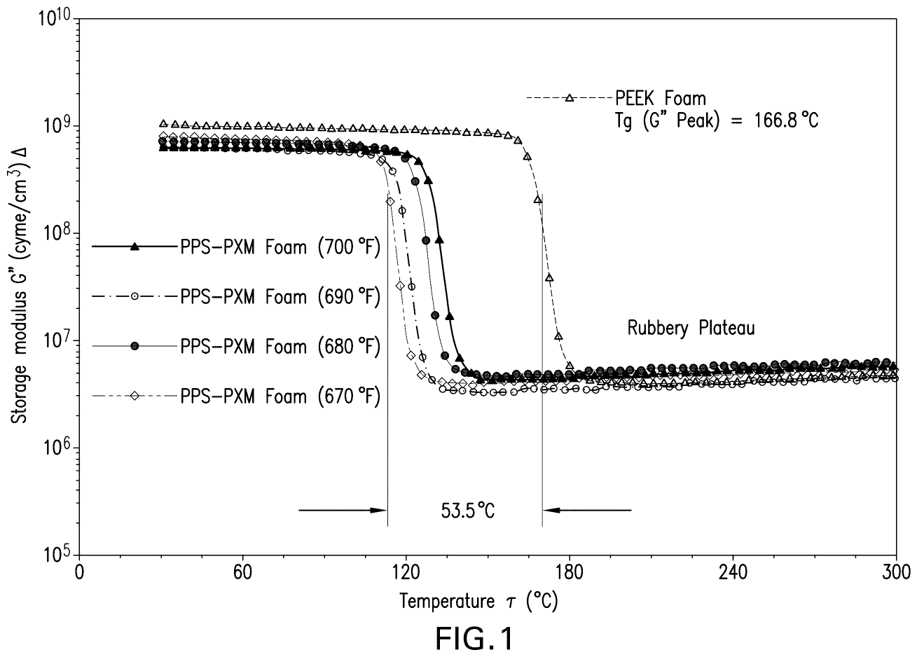

An observed technical advantage for making the crosslinked polymeric material from PPS-PXM is the ability to control the glass transition temperature of the polymeric material, that is, the glass transition temperature of the polymeric material downhole in a fluid control device. As the sintering temperature over a determined period of time is increased, e.g., from a temperature of 320° C. to 390° C., e.g., 340° C. to 370° C., the glass transition temperature of the crosslinked polymeric material also increases over a range of about 50° C. As indicated in FIG. 1, the amorphous crosslinked polymeric material prepared from PPS-PXM can be designed to have a glass transition temperature from 95° C. to 140° C. This provides an opportunity to use the polymeric material in a relatively lower temperature borehole formation. Moreover, the glass transition temperature can be programmed into the material for a given borehole formation depending upon the temperature at the borehole.

The crosslinked polymeric material prepared from PEEK is shown to exhibit less sensitivity in the relationship between sintering temperature and glass transition temperature. A polymeric material prepared from PEEK exhibits a glass transition temperature at about 167° C., which make the latter more suitable for relatively higher temperature borehole formations. See. FIG. 3.

In either embodiment above, as the temperature of a compressed polymeric material increases within a fluid control device due to the higher temperatures at the borehole, the temperature of the polymeric material eventually reaches and surpasses the glass transition temperature of the polymeric material, and the compressed material begins to soften as described. Eventually, the polymeric material begins to expand to approximate previously manufactured shape and volume.

In another embodiment, the polymeric material can be expanded downhole by introducing a “triggering fluid”. In the presence of a triggering fluid the glass transition temperature of the polymeric material is reduced and the formation temperature downhole is now sufficient to soften the material resulting in the expansion of volume to its previously manufactured shape and volume. The expansion recovery of the polymeric material to its manufactured shape and volume is referred as a shape memory property. The shape memory property allows for expansion from the compressed volume and shape to about the initial volume and shape as described. For example, to about 90% to 110% of the initial volume and shape.

For example, a polymeric material prepared from polyphenylene sulfide polymer and subjected to the heat-treatment and extraction steps to form a permeable polymeric material as described can be compressed to about 20% to 60%, or 20% to 40%, of the initial volume of the polymeric material. The compressed polymeric material may then be allowed to expand under the conditions of expansion described to about 90% to 105% of the original volume. In other words, a polymeric material that is compressed to about 28% of the original volume will upon near full expansion to its original volume exhibit an expansion ratio of about 268%, that is, (1−0.28)/0.28 or 268% The expanded shape of the porous material can be used in downhole environment as a totally conformable sand control screen to prevent sands or other undesired contaminants in the production fluid. The fluid control devices as described should provide greater cost efficiency in fluid production, for example, in contrast with known gravel packing methods.

### Fluid Control Device

The polymeric material describe can be one component of a filtration medium or screen assembly that is deployed downhole in conjunction with a tool or component to filter a production fluid. As described and prior to deployment, the polymeric material is compressed or in a compacted form. As described, the polymeric material is heated to a temperature above a glass transition temperature of the polymeric material, compacted and quickly cooled and retains its compacted shape or volume. The polymeric material may then be positioned in a screen assembly and expanded downhole, for example, due to downhole temperatures above the glass transition temperature, and/or in the presence of a triggering fluid that reduces the glass transition temperature to a temperature below the downhole temperature.

After expansion, the available increase in porosity of the filtration medium (polymeric material) is used to filter sand, particulates and other undesirable material from the production fluid. It is noted that the filtration medium or polymeric material may be configured as one or more layers, either alone or in combination with one or more additional filtration layers or devices, such as perforated sleeves, wire mesh, bead screens and/or others.

Embodiments described herein present a number of advantages. The filtration media including the polymeric material and screen assemblies described can be used in both low and high temperature environments. The filtration medium including the polymeric material can also be used as an expandable fluid control device that can be deployed for longer periods than conventional screens and shape memory components and can be a viable alternative to gravel packing systems.

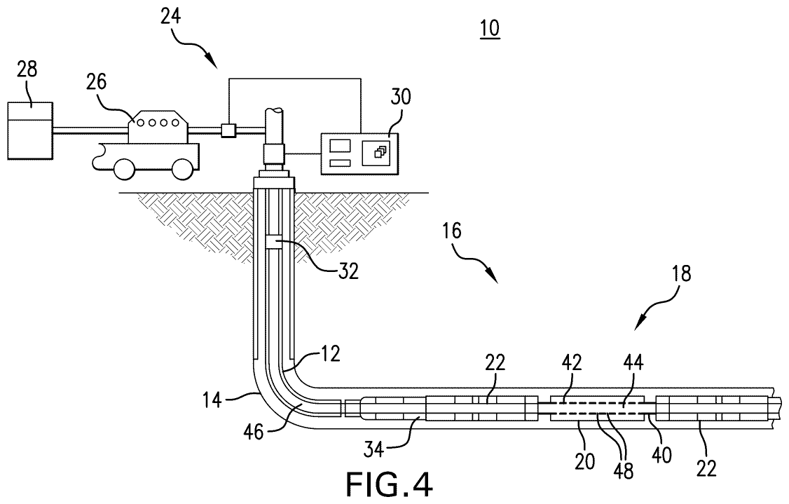

FIG. 4 depicts an example of a system 10 configured to perform a subterranean operation and illustrates an example of a screen assembly including a conformable and expandable filtration medium that includes a polymeric material. The system 10 is a resource or energy production system 10 that includes a borehole string 12 disposed in a borehole 14 extending into a subterranean region or a resource bearing formation, such as an earth formation 16. It is noted that the filtration medium is not limited to this schematic representation and can be incorporated into any suitable downhole device or component known in the art of production drilling.

The borehole string 12 includes a completion string having a production assembly 18. The production assembly 18 includes a screen assembly 20 and may also include a flow control device such as an inflow control device (ICD). The production assembly 18 may include additional components such as one or more packer assemblies 22 configured to isolate components and/or zones in the borehole 12.

The system 10 also includes surface equipment 24 such as a drill rig, rotary table, top drive, blowout preventer and/or others to facilitate deploying the borehole string 12, operating various downhole components, monitoring downhole conditions and controlling fluid circulation through the borehole 14 and the borehole string 12. For example, the surface equipment 24 may include a fluid control system 26 including one or more pumps in fluid communication with a fluid tank 28 or other fluid source. The fluid control system 28 facilitates injection of fluids, drilling fluid (e.g., drilling mud), stimulation fluid (e.g., a hydraulic fracturing fluid), gravel slurries, proppant, and others. The fluid control system 28 or other suitable system may be used to inject fluids, such as a triggering fluid to expand the polymeric material from it previously compacted volume or shape.

One or more components of the borehole string 12 may be configured to communicate with a surface location (e.g., the surface equipment 24). The communication may be wired or wireless. A processing device such as a surface processing unit 30 and/or a subsurface processing unit 32 and/or 34, which may be disposed in the borehole 14 and connected to one or more downhole components. The processing device may be configured to perform functions such as controlling downhole components, transmitting and receiving data, processing measurement data and/or monitoring operations. The processing device may also control aspects of fluid circulation and injection.

The screen assembly 20 in this embodiment includes a base pipe 40 and an expandable and conformable filtration medium 42. The base pipe 40 defines an inner fluid conduit 44 that can be connected to a borehole string or otherwise in fluid communication with a selected location such as a surface location. For example, the inner fluid 44 is in fluid communication with a production conduit 46 connected to the surface. A plurality of holes or other fluid passages 48 provide fluid paths for fluid entering through the filtration medium 42 (e.g., after degradation and removal of the shape memory polymeric material) to flow through the base pipe 40 and into the inner fluid conduit 44. For greater detail in regard to a screen assembly 20, the disclosure of U.S. Pat. No. 8,048,348, assigned to Baker Hughes Inc., is incorporated herein by reference, see, FIGS. 1 and 2, and column 8, line 46 to column 9, line 10.

The polymeric material is configured to be resistant to temperatures present in downhole environments. In one embodiment, the polymeric material can be deployed in environments up to at least about 400° C. The high temperature and chemical resistance of the polymeric material, in combination with its shape memory properties provides for an expandable and conformable screen assembly or device that can be effectively used in both high or low temperature environments as compared to conventional screens and conventional shape memory polymers.

As noted, the filtration medium 42 may be compacted from an initial shape to a compacted form. In its compacted form shape, the polymeric material is positioned within a screen assembly or another component. The polymeric material retains the compacted shape as long as the temperature of the material remains below the glass transition temperature of the material. Then, as the polymeric material is heated above the glass transition temperature (e.g., when deployed in a borehole), the material positioned in the fluid passages expands, causing the filtration medium 42 to fully or partially recover to the initial shape and original porosity.

Although embodiments are discussed in the context of sand control and as part of the system 10, it is to be understood that the embodiments are not so limited. The medium 42 may be configured for any desired downhole application (or surface application) and thus have any suitable shape, size, material composition and chemical composition.

The filtration medium 42 may be part of a screen device or assembly that includes additional layers or filtration components. For example, the screen assembly 20 may be made from one or more layers of the porous medium 42, in combination with one or more additional filtration elements or layers, such as metal screens, wire mesh, polymeric screens, mesh wool, bead screens, and/or others.

Embodiments described herein provide an effective means to control sand and prevent undesired materials from entering a production string or being produced. The devices described herein can be configured to operate effectively at a wide range of temperatures, including temperatures higher than those at which conventional sand control devices operate. In addition, the filtration medium described herein can be scaled to accommodate various sizes of tubulars and other components.

### EXAMPLES

### Example 1: Preparation of Polymeric Material From PEEK Polymer Precursor

65 grams of Morton table salt and 15 grams of PEEK powder (commercially available from Syensqo as KetaSpire® are added to a plastic bottle and the mixed solids are blended by hand-shaking the bottle for about one minute. The mixed powders are poured into a steel mold which includes a bottom plate, a center ring and a piston. After the mixed powders are poured into the cavity of the steel mold, the piston is placed inside the center ring. The mold which contains the mixed powders is placed under a bench hydraulic press. About 1000 psi pressure is applied to the blended salt and polymer. The pressure is then released, and the compressed solid is removed from the mold. The compressed solid is placed in an oven and heated to 370° C. and the temperature is maintained at 370° C. for at least 5 hours. After cool down to ambient temperature, the heated compressed solid is placed in a water bath and temperature is raised to boiling, and the solid is maintained in the boiling water for about 8 hours. The solid is removed from the water bath, and placed in an oven maintained at a temperature of 110° C. for about 8 hours.

The polymeric material prepared in Example 1 is then compressed and instilled with shape memory as follows. The polymeric material temperature is raised above its glass transition temperature Tg, and once above the glass transition temperature the material starts to soften and follows the rubbery plateau. As indicated in FIG. 1, the rubbery plateau is reached at a temperature of about greater than 180° C. Accordingly, the compression of the material is possible at a temperature from 180° C. or higher, e.g., to 200° C. to 240° C. At this temperature the polymeric material is compressed to a desired shape and rapidly cooled, e.g., by quenching the material in water.

### Example 2: Preparation of Polymeric Material From PPS-PXM Polymer Precursor

60 grams of Morton table salts and 20 grams of PPS-PXM polmer (commercially available from Syensqo as Ryton® PPS-PXM) are added in a plastic bottle. The blending and compaction procedure is repeated as in Example 1. The compacted solid is placed in an oven and heated to 360° C. and the temperature is maintained at 360° C. for at least 5 hours (sintering temperature). After cool down to ambient temperature, the heated solid is placed in a water bath and temperature is raised to boiling, and the solid is maintained in the boiling water for about 8 hours. The solid is removed from the water bath and placed in an oven maintained at a temperature of 110° C. for about 8 hours.

The polymeric material prepared in Example 2 is then compressed and instilled with shape memory as follows. The polymeric material temperature is raised above its glass transition temperature, Tg, and once above the glass transition temperature the material begins to soften and exhibits the rubbery plateau. As indicated in FIG. 1, the rubbery plateau is reached at a temperature of about greater than 120° C. Accordingly, the compression of the material is possible at a temperature from 120° C. or higher, e.g., 150° to 180° C. At this temperature the polymeric material is compressed to a desired shape and rapidly cooled, e.g., by quenching the material in water.

Set forth below are some embodiments of the foregoing disclosure:

### Embodiment 1

A material, comprising: a crosslinked polymeric material with a dry density of 0.1 g/cm³ to 0.7 g/cm³, and an open volume of 60% to 99.5%, based on a total of open and closed volume; wherein the crosslinked polymeric material exhibits a rubbery plateau above the glass transition temperature of a precursor polymer from which the material is prepared.

### Embodiment 2

The material of any prior embodiment, wherein the crosslinked polymeric material is a product of a compacted admixture of the precursor polymer and a salt to provide that is heated to a temperature above the melting point of the precursor polymer, and the salt is removed by extraction to provide the crosslinked polymeric material as a permeable material, wherein in the compacted admixture a weight ratio of the salt to the precursor polymer is from 10:1 to 2:1.

### Embodiment 3

The material of any prior embodiment, wherein the open volume is greater than 80%.

### Embodiment 4

The material of Embodiment 3, wherein the salt is a water-soluble salt and has a mesh size in the range of 400 to 5.

### Embodiment 5

The material of any prior embodiment, wherein the precursor polymer is selected form the group consisting of polyether ether ketone (PEEK), polyetherketoneketone (PEKK), polyphenylene sulfide (PPS), polyphenylsulfone} (PPSU), polytetrafluoroethylene (PTFE), and perfluoroalkoxy alkanes.

### Embodiment 6

The material of any prior embodiment, wherein the precursor polymer is polyether ether ketone (PEEK), polyetherketoneketone (PEKK), or polyphenylene sulfide (PPS).

### Embodiment 7

The material of any prior embodiment, wherein the precursor polymer comprises PPS-PXM with a molecular weight greater from 10,000 g/mol to 100,000 g/mol.

### Embodiment 8

The material of any prior embodiment, wherein the crosslinked polymeric material has a glass transition temperature that increases with an increase in sintering temperature over a determined period of time, wherein the sintering temperature is in a range from 340° C. to 390° C.

### Embodiment 9

The material of any prior embodiment, wherein the crosslinked polymeric material has a glass transition temperature from 95° C. to 140° C.

### Embodiment 10

The material of any prior embodiment, wherein the dry density of the crosslinked polymeric material is 0.2 g/cm³ to 0.3 g/cm^{3 .}

### Embodiment 11

A fluid control device comprising: a support structure including a fluid passage and configured to be deployed in a borehole; a filtration medium including a crosslinked polymeric material, the filtration medium disposed in contact with the support structure; wherein the crosslinked polymeric material is configured to expand and remain in contact with the support structure to increase permeability of the filtration medium, wherein the expanded crosslinked polymeric material has a density of 0.1 g/cm³ to 0.7 g/cm³, an open volume of 60% to 99.5%, and exhibits a rubbery plateau above the glass transition temperature of a precursor polymer from which the crosslinked polymeric material is prepared.

### Embodiment 12

The device of Embodiment 11, wherein the crosslinked polymeric material has a glass transition temperature that is less than a downhole temperature at or near the borehole, or the crosslinked polymeric material is configured to expand within the support structure upon exposure to a triggering fluid, wherein the triggering fluid lowers the glass transition temperature of the polymeric material.

### Embodiment 13

The device of any prior device embodiment, wherein the precursor polymer is selected form the group consisting of polyether ether ketone (PEEK), polyetherketoneketone (PEKK), polyphenylene sulfide (PPS), polyphenylsulfone} (PPSU), polytetrafluoroethylene (PTFE), and perfluoroalkoxy alkanes.

### Embodiment 14

The device of any prior embodiment, wherein the precursor polymer comprises polyphenylene sulfide with a molecular weight greater than 10,000 g/mol, wherein the crosslinked polymeric material has a glass temperature from 95° C. to 140° C., the glass transition temperature increasing with an increase in sintering from 340° C. to 390° C. over a determined period of time.

### Embodiment 15

The device of any prior embodiment, wherein the support structure includes a screen assembly configured to filter a production fluid entering the borehole, the support structure including a conduit structure within a tubular structure for the fluid to flow, and the filtration medium at least partially surrounding the tubular structure.

### Embodiment 16

A fluid control method comprising: deploying the fluid control device of any one device Embodiment 11 to 15 in the borehole, wherein the crosslinked polymeric material is in a compressed form during deployment; expanding the compressed polymeric material in the plurality of fluid passages to provide an increase in permeability to the filtration medium, the expanded polymeric material conforming to a surface of the support structure; and allowing a fluid to flow through the filtration medium to separate and remove undesirable material from the fluid.

### Embodiment 17

The fluid control method of Embodiment 16, wherein the expanding of the compressed polymeric material is achieved by: the polymeric material having a glass transition temperature that is less than a downhole temperature at or near the borehole; or contacting the polymeric material with a triggering fluid, wherein the triggering fluid lowers the glass transition temperature of the polymeric material, wherein the expanded polymeric material has an open volume of greater than 80% based on a total of open and closed volume of the material.

### Embodiment 18

A method of making a permeable polymer material, the method comprising: blending a salt and a precursor polymer to provide an admixture; compacting the admixture under pressure in a mold to provide a compacted admixture; heating the compacted admixture to a temperature above the glass transition temperature of the precursor polymer; extracting the salt from the heat-treated admixture to provide the polymer material.

### Embodiment 19

The method of Embodiment 18 further comprising compressing the permeable material under pressure, wherein the compressing includes raising the temperature of the polymer material at or above the glass transition temperature of the material.

### Embodiment 20

The method of Embodiment 19, wherein the compressing of the polymeric material provides a compressed polymeric material having a volume that is 15% to 70% of the volume of the extracted polymeric material.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. cm 1.-10. (canceled)

11. A fluid control device comprising:
a support structure including a fluid passage and configured to be deployed in a borehole; and
a filtration medium including a crosslinked polymeric material, the filtration medium disposed in contact with the support structure; wherein the crosslinked polymeric material is configured to expand to form an expanded, amorphous, crosslinked polymeric material that remains in contact with the support structure to increase permeability of the filtration medium,
wherein the expanded, amorphous, crosslinked polymeric material has a density of 0.1 g/cm³ to 0.7 g/cm³, an open volume of 60% to 99.5%, and exhibits a rubbery plateau above the glass transition temperature of a precursor polymer,
wherein the precursor polymer is selected from the group consisting of a fluoropolymer, an aromatic polyamide, polyether ether ketone (PEEK), polyetherketoneketone (PEKK), and a combination thereof.

12. The device of claim 11, wherein the crosslinked polymeric material has a glass transition temperature that is less than a downhole temperature at or near the borehole, or
the crosslinked polymeric material is configured to expand within the support structure upon exposure to a triggering fluid, wherein the triggering fluid lowers the glass transition temperature of the crosslinked polymeric material.

13. The device of claim 11, wherein the precursor polymer is selected from polytetrafluoroethylene (PTFE), or perfluoroalkoxy alkanes

14. (canceled)

15. The device of claim 11, wherein the support structure includes a screen assembly configured to filter a production fluid entering the borehole, the support structure including a conduit structure within a tubular structure for the fluid to flow, and the filtration medium at least partially surrounding the tubular structure.

16. A fluid control method comprising:
deploying the fluid control device of claim 11 in the borehole, wherein the crosslinked polymeric material is in a compressed form during deployment;
expanding the compressed polymeric material in the plurality of fluid passages to provide an increase in permeability to the filtration medium, the expanded polymeric material conforming to a surface of the support structure; and
allowing a fluid to flow through the filtration medium to separate and remove undesirable material from the fluid.

17. The fluid control method of claim 16, wherein the expanding of the compressed polymeric material is achieved by:
the polymeric material having a glass transition temperature that is less than a downhole temperature at or near the borehole; or
contacting the compressed polymeric material with a triggering fluid, wherein the triggering fluid lowers the glass transition temperature of the polymeric material,
wherein the expanded polymeric material has an open volume of greater than 80% based on a total of open and closed volume of the material.

18. A method of making a permeable material, the method comprising:
blending a salt and a precursor polymer to provide an admixture;
compacting the admixture under pressure in a mold to provide a compacted admixture;
heating the compacted admixture to a temperature above the glass transition temperature of the precursor polymer; and
extracting the salt from the heat-treated admixture to provide the polymeric material.

19. The method of claim 18 further comprising compressing the polymeric material under pressure, wherein the compressing includes raising the temperature of the polymeric material at or above the glass transition temperature of the material.

20. The method of claim 19, wherein the compressing of the polymeric material provides a compressed polymeric material having a volume that is 15% to 70% of the volume of the extracted polymeric material.

21. The device of claim 11, wherein the precursor polymer is selected form the group consisting of fluorinated ethylene propylene (FEP), perfluoroalkoxy polymer (PFA), or polytetrafluoroethylene (PTFE), self-reinforced polyphenylene (SRP), or a combination thereof.

22. The device of claim 11, wherein the precursor polymer is polyether ether ketone (PEEK) or polyetherketoneketone (PEKK).

23. The device of claim 11, wherein the precursor polymer comprises PPS-PXM with a molecular weight greater from 10,000 g/mol to 100,000 g/mol, and the amorphous, crosslinked polymeric material derived from the PPS-PXM has a glass transition temperature that increases with an increase in sintering temperature over a determined period of time, wherein the sintering temperature is in a range from 340° C. to 390° C.

24. The device of claim 11, wherein the amorphous, crosslinked polymeric material is prepared by a process comprising:
providing a compacted admixture of the precursor polymer and a salt, wherein the compacted admixture has a weight ratio of the salt to the precursor polymer of from 10:1 to 2:1, and the salt has a particle size in a range from about 0.1 to 2 mm;
heat-treating the compacted admixture to a temperature above the melting point of the precursor polymer,
extraction of the salt from the heat-treated compacted admixture to provide a compacted, amorphous, crosslinked polymeric material;
heating the compacted, amorphous, crosslinked polymeric material about 20° C. to about 70° C. above the glass transition temperature to an expanded volume; and
locking in a shape and a volume of the amorphous, crosslinked polymeric material by compression followed by a lowering of the temperature of the material significantly below the glass transition temperature,
wherein the precursor polymer selected from the group consisting of a fluoropolymer, an aromatic polyamide, polyether ether ketone (PEEK), polyetherketoneketone (PEKK), and a combination thereof.
